(19) United States
(12) Patent Application Publication
(10) Pub. No.: US 2025/0383048 A1
(43) Pub. Date: Dec. 18, 2025

(54) FIRE SUPPRESSION SYSTEM DRIVE-AIR STORAGE

(71) Applicant: Tyco Fire Products LP, Cranston, RI (US)

(72) Inventors: Jeremie LeClair, Foxborough, MA (US); James Leuzarder, Wakefield, RI (US); Zachary L. Magnone, Warwick, RI (US)

(73) Assignee: Tyco Fire Products LP, Cranston, RI (US)

(21) Appl. No.: 19/213,296

(22) Filed: May 20, 2025

Related U.S. Application Data
(60) Provisional application No. 63/659,194, filed on Jun. 12, 2024.

(51) Int. Cl. F17C 5/06

(52) U.S. Cl. CPC F17C 5/06; F17C 2221/014; F17C 2221/031; F17C 2223/036; F17C 2227/0135; F17C 2270/025

(57) ABSTRACT

An air replenishment system can include a first tank to supply gas to a regulator via a first fluid channel, and a second tank to supply air to a pump via a second fluid channel. The regulator can provide the gas from the first tank to the pump at a pressure that can be lower than a pressure of the air supplied from the second tank to the pump. The first fluid channel can be separate from the second fluid channel.

### CROSS-REFERENCE TO RELATED APPLICATIONS

The present application claims the benefit of and priority to U.S. Provisional Application No. 63/659,194, filed Jun. 12, 2024, the disclosure of which is incorporated herein by reference in its entirety.

### BACKGROUND

A structure (e.g., a vertical building, a horizontal building, a tunnel, marine craft) can have a firefighter air replenishment system (FARS) implemented therein. The FARS can include one or more alternatives for drive air storage.

### SUMMARY

At least one aspect is directed to an air replenishment system. The air replenishment system can include a first tank to supply gas to a regulator via a first fluid channel. The air replenishment system a second tank to supply air to a pump via a second fluid channel. The air replenishment system the regulator can provide the gas from the first tank to the pump at a pressure that is lower than a pressure of the air supplied from the second tank to the pump. The air replenishment system can include the first fluid channel being separate from the second fluid channel.

At least one aspect is directed to an air replenishment method. The air replenishment method can include supplying gas from a first tank to a regulator via a first fluid channel. The air replenishment method can include supplying air from a second tank to a pump via a second fluid channel. The air replenishment method can include providing, by the regulator, the gas from the first tank to the pump at a pressure that is lower than a pressure of the air supplied from the second tank to the third tank, with the first fluid channel being separate from the second fluid channel.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 depicts a schematic diagram of an example of a first firefighter air replenishment system (FARS);

FIG. 2 depicts an example of a first distribution of unused air, drive air, and breathable air, using the first FARS;

FIG. 3 depicts a schematic diagram of an example of a second FARS;

FIG. 4 depicts an example of a second distribution of unused air, drive air, and breathable air, using the second FARS;

FIG. 5 depicts a schematic diagram of an example of a third FARS;

FIG. 6 depicts an example of a third distribution of unused air, drive air, and breathable air, using the third FARS;

FIG. 7 depicts a schematic diagram of an example of a fourth FARS;

FIG. 8 depicts an example of a fourth distribution of unused air, drive air, and breathable air, using the fourth FARS; and

FIG. 9 depicts a flow diagram illustrating an example method for alternatives for drive air storage.

### DETAILED DESCRIPTION

Following below are more detailed descriptions of various concepts related to, and implementation of systems and methods of firefighter air replenishment systems (FARSs), such as a FARS that can implement a plurality of alternatives for drive air storage. The various concepts introduced above and discussed in greater detail below can be implemented in any of numerous ways, including in standby operation of air pipes in buildings implementations.

FARS can be used to provide air, such as pressurized air, to a firefighter, to a booster pump, or an air refill station within an environment, such as a building or other structure in which access to breathable air may be limited. Such systems can rely on air to drive the pump(s), such as air from the breathing air supply and/or from a compressor. The amount of pressurized air available to the firefighter can vary depending on the topology of the drive air storage. For example, a topology that uses one tank to provide breathable air to the air refill station and supply drive air to the pumps in a FARS can have a reduced amount of breathable air for the firefighter during an incident (e.g., a fire, air pollution, smoke) occurring within the structure. The topology can result in a limited amount of air within the tank to be supplied to the firefighter and rendering the majority of air within the tank unusable and wasted to maintain the FARS. Therefore, the topology can raise issues with the availability of air within complex structures, such as a multi-story building or tunnels. For example, providing for mass and/or volume of drive air can involve one or more of an air compressor (e.g., shop air compressor) to drive pneumatic booster pumps; additional storage cylinders of breathing air to supply drive air (rather than to be used as breathing air); and/or larger space (e.g., room footprint) in the building to support one or more such components.

Systems and methods in accordance with the present disclosure can implement a FARS with a plurality of topologies to increase the amount of breathable air for a firefighter or an air refill station while maintaining optimal performance of the FARS. This can include, for example, the use of storage tanks allocated to drive pneumatic booster pumps of the FARS; the use of storage tanks allocated to supply breathable pressurized air to the pneumatic booster pumps for the firefighter or the air refill station; the use of check valves to couple and decouple fluid channels connecting the storage tanks; one or more configurations of the storage tanks to improve the amount of breathable air; and/or regulators to provide a minimum pressure for the pneumatic booster pumps. Various such components and operating modes of the FARS can allow for the amount of breathable air (e.g., breathable air to the firefighters) to increase while reducing the unused air in the FARS. For example, systems and methods in accordance with the present disclosure can allow for drive air storage topologies (e.g., upstream of where the drive air is run through the pump) that can reduce the required drive air mass or standard volume. This can allow for FARS systems that require less installation space, fewer storage cylinders or smaller shop compressors, and/or less complex installation and/or maintenance, for example.

For example, a system can have separate drive air storage and breathing air storage. The drive air and breathing air may both be of breathing air quality; the drive air may be lower and/or non-breathable quality, or motive gas; the drive air may be sourced from an existing source of gas where a source of sufficient quality is available, such as boiled off nitrogen at facilities with bulk or micro-bulk systems; the drive air may be stored as a high density (solid or liquid) material, which can be expanded to gas to be used as drive air, e.g., using refrigerant gasses. The system can include one or more check valves between the drive air storage and breathing air storage (e.g., where the drive air is of breathing air quality). The air storage can be provided in three or more separable banks to provide for drive and/or breathing air modularity. The system can use a check regulator system, where each storage system can be deployed as a separate air reservoir. One or more such features can allow the system to separately provide drive air and breathing air storage and/or

For example, a system (e.g., FARS) can include a tank (e.g., drive air storage tank). The drive air storage tank can house pneumatic air or house nitrogen gas to operate shop compressors or pneumatic booster pumps at a pressure of at least 100 psig to maintain the standby pressure and the operating pressure. The system can include a second tank to provide breathable air to the pneumatic booster pumps for a firefighter or a refill station. The system can include a fluid channel to direct the gas to a regulator. The system can include another fluid channel to provide air to the pneumatic booster pumps for a firefighter or a refill station. The system can include a regulator to provide gas to the pneumatic booster pumps. This can allow, for example, unused air associated with the system to be decreased to below fifty percent (e.g., compared to systems where more than half of the available air is used as drive air).

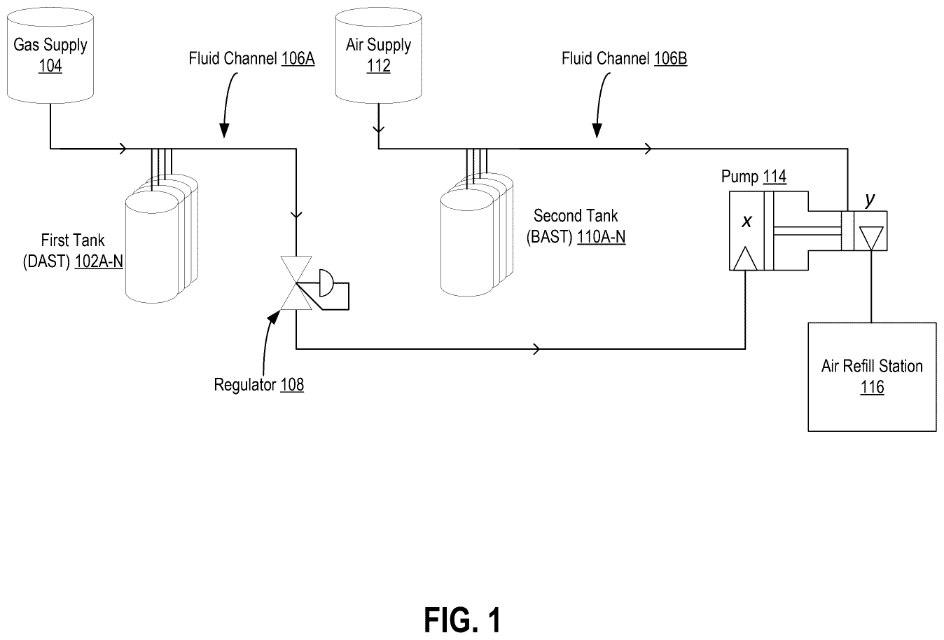

FIG. 1 depicts an example of a system 100, such as a safety system or FARS. The system 100 can be a separate reservoir system indicated by separate storages for drive air (e.g., gas, nitrogen) and breathable air (e.g., ambient air). The system 100 can allow firefighters to have access to higher amount of breathable air (e.g., human breathable air) when inside a structure during a fire related emergency. The structure can be any vertical or horizontal building structure such as shopping malls, extended shopping, storage and/or warehousing related structures, tunnels, marine craft (e.g., large marine vessels such as cruise ships, cargo ships, submarines and large naval craft, which may be floating versions of buildings and horizontal structures), and mines. For example, the system 100 can utilize available air or gas in a manner to effectively decrease the amount of unused air while increasing the amount of breathable air for a firefighter.

The system 100 can include at least one first tank 102A-N (generally referred to as drive air storage tank (DAST) 102 or first tank 102 herein), which can be filled with at least one of breathable air (e.g., nitrogen, oxygen, carbon dioxide, and some trace gases) or non-breathable air (e.g., carbon monoxide, sulfur dioxide, nitrogen dioxide, etc.) at air refill stations 116 or gas fill stations within the structure or a firehouse. For example, the first tank 102 can be filled with breathable air for an air refill station 116 within a shopping mall or for a SCBA tank of a firefighter. In another example, the first tank 102 can be filled with motive gases (e.g., nitrogen or carbon dioxide) while in a firehouse.

The system 100 can include at least one gas supply 104 coupled to the first tank 102 to fill the first tank 102 with breathable air or non-breathable air. The gas supply 104 can be a storage tank a refill station stored within the structure (e.g., building, shopping mall, tunnels, etc.), a firehouse, or a vehicle. For example, when a fire department vehicle arrives at the structure, a firefighter can use the gas supply 104 of the fire department vehicle to fill the first tank 102. In another example, a firefighter can use the gas supply 104 of a gas refill station within a shopping mall to fill the first tank 102.

The gas supply 104 can be stored at one or more locations within the structure, the firehouse, or the fire department vehicle. For example, the fire department vehicle can have a first gas supply 104 on the left side of the fire department vehicle and can have a second gas supply 104 on the right side of the fire department vehicle. The gas supply 104 can store or hold motive gas, argon, oxygen, methane gas, carbon dioxide, helium, among others. For example, the gas supply 104 can store methane gas for the first tank 102. In another example, the gas supply 104 can store carbon dioxide for the first tank 102. In yet another example, the gas supply 104 can store oxygen and nitrogen.

The gas supply 104 can house non-breathable air or breathable air (referred to as “fuel”) in the form of at least one of a high density solid state, a high density liquid state, or a high density gaseous state. When the fuel is stored as the high density liquid or the high density solid, the gas supply 104 can boil the fuel to expand the high density liquid or the high density solid to the high density gas. For example, the gas supply 104 can include liquid nitrogen at the fill station within the structure. Prior to filling the first tank 102, the gas supply 104 can boil the liquid nitrogen to create gaseous nitrogen. The gas supply 104 can provide the liquid nitrogen to the first tank 102 via an outlet connection.

The gas supply 104 can include the outlet connection (e.g., fluid channel 106A) to couple to the first tank 102. The fluid channel 106A can couple the gas supply 104 with the first tank 102. For example, the fluid channel 106A can fluidically couple the gas supply 104 with the first tank 102. The fluid channel 106A can include at least one of an inlet port, piping, a manifold, sampling points, filters, or valves to transport high density gas or a high density liquid from the gas supply 104 to the first tank 102. For example, the gas supply 104 can provide pneumatic air (e.g., breathable air) to the inlet port of the fluid channel 106A. The pneumatic air can travel through the piping and one or more filters of the fluid channel 106A to reach the first tank 102. Using fluid channel 106A, the gas supply 104 can supply non-breathable air or breathable air to the first tank 102 and a regulator 108.

The system 100 can include at least one regulator 108 to couple with the first tank 102 via the fluid channel 106A. The regulator 108 can be a pressure regulator. The regulator 108 can include at least one of an inlet connection, a pressure reducing mechanism, adjustment knob, a pressure gauge, an outlet connection, and safety features to control the flow of non-breathable or breathable air within the fluid channel 106A. For example, nitrogen gas can enter the regulator 108 through the inlet connection. The nitrogen gas can flow to the pressure reducing mechanism; the regulator 108 (e.g., according to a setting of the adjustment knob) can reduce the pressure (in psig) of the nitrogen gas flowing out of the regulator 108 through the outlet connection. The pressure gauge can show the pressure of the nitrogen flowing out of the regulator 108.

The system 100 can include at least one second tank 110A-N (generally referred to as breathable air storage tanks (BAST) 110 or second tanks 110 herein), which can be filled with at least one of breathable air (e.g., nitrogen, oxygen, carbon dioxide, ambient air, pneumatic air or trace gases) at air fill stations within the structure or a firehouse. For example, the second tank 110 can be filled with breathable air at an air fill station of a shopping mall. The second tank 110 can be separate from the first tank 102. For example, the second tank 110 can be coupled to an air supply 112 via a fluid channel 106B, whereas the first tank 102 can be coupled with the gas supply 104 via the fluid channel 106A.

The system 100 can include at least one the air supply 112 to fill the second tank 110 with breathable air. The air supply 112 can be a storage tank a refill station stored within the structure (e.g., building, shopping mall, tunnels, etc.), a firehouse, or a vehicle. For example, when a fire department vehicle arrives at the structure, a firefighter can use the air supply 112 of the fire department vehicle to fill the second tank 110. In another example, a firefighter can use the air supply 112 of an air fill station within a shopping mall to fill the second tank 110.

The air supply 112 can be stored at one or more locations within the structure, the firehouse, or the fire department vehicle. For example, the fire department vehicle can have a first air supply 112 on the left side of the fire department vehicle and can have a second air supply 112 on the right side of the fire department vehicle. The air supply 112 can store or hold ambient air (e.g., nitrogen, oxygen, carbon dioxide) or pneumatic air. For example, the air supply 112 can store ambient air for the second tank 110. In another example, the air supply 112 can store pneumatic air for the second tank 110. In yet another example, the air supply 112 can store purely oxygen and nitrogen.

The air supply 112 can house breathable air (e.g., fuel) in the form of a high density gas. For example, the air supply 112 can include high density ambient air at the fill station within the structure. The air supply 112 can provide the high density ambient air to the second tank 110 via an outlet connection. For example, the air supply 112 can transmit high density ambient air to the second tank 110, using the outlet connection.

The air supply 112 can include the outlet connection (e.g., fluid channel 106A) to couple with the second tank 110. The fluid channel 106B can couple the air supply 112 with the second tank 110. For example, the fluid channel 106B can fluidically couple the air supply 112 with the second tank 110. The fluid channel 106B can include at least one of an inlet port, piping, a manifold, sampling points, filters, or valves to transport high density gas or a high density liquid from the air supply 112 to the second tank 110. For example, the air supply 112 can provide pneumatic air (e.g., breathable air) to the inlet port of the fluid channel 106A. The pneumatic air can travel through the piping and one or more filters of the fluid channel 106B to reach the second tank 110. Using fluid channel 106B, the air supply 112 can supply breathable air to the second tank 110 and a booster pump 114.

The system 100 can include at least one fluid channel 106B. The fluid channel 106B can fluidically couple the air supply 112, the second tank 110, and the pump 114 to an air refill station 116. The air refill station 116 can supply breathing air to the firefighter in environments of smoke, toxic gas, or reduced oxygen levels. For example, the air refill station 116 can provide breathable air to the SCBA of a firefighter within a structure on fire. The air refill station 116 can include a compressor, a filtration system, storage tanks, pressure regulators, cooling system, control systems, a fill station, and an emergency alert system. In operation, the compressors and the filtration system can compress and clean the breathable air from the second tank 110. air refill station 116 can house the compressed air in one or more storage tanks to allow for quicker refills of the SCBA. The pressure regulator can control the pressure of the compressed air within the storage tanks of the air refill station.

The system 100 can include at least one fluid channel 106A. The fluid channel 106A can fluidically couple the first tank 102, the gas supply 104, and the regulator 108 together to provide drive air (e.g., non-breathable or breathable air) to one or more shop compressors or pneumatic booster pump 114 (generally referred to as “pump 114). The pump 114 can supply dry compressed non-breathable air or breathable air to manage the functions of the FARS or the emergency alert system of the air refill station 116. For example, the pump 114 can clean the non-breathable air transmitted from the regulator 108. Once clean, the pump 114 can supply the emergency alert system of the air refill station 116 with compressed non-breathable air.

The system can include at least one pump 114. The pump 114 can at least partially driven by gas from the first tank 102, such as to be powered by the pressure of gas from the first tank 102 (e.g., to operate as a booster pump and/or bootstrapped booster pump). For example, pump 114 can include an air splitter (e.g., valve, filter, tee joint) to separate at least a portion of the air from the second tank 110 between a first path for air (e.g., fluid channel 106B) to be outputted and a second path (e.g., fluid channel 106A) to drive one or more pump components (e.g., compressors, fans, impellers) of the pump 114 that compress the air on the first path. The pump 114 can output the air from the fluid channel 106B, such as for delivery to the air refill stations 116.

The system can include at least one air refill station 116. The air refill station 116 can be coupled to the pump 114 and can refill the SCBA of the firefighter. The air refill station 116 can provide firefighters with a continuous supply of breathable air during a fire hazard. The air refill station 116 can include a compressor unit, a storage cylinders, a fill station, a control system, and a cooling system. In operation, the compressor unit can compress ambient air to high pressures and filter the compressed air. The compressed ambient air can be stored within storage tanks of the air refill station 116. The control system can control the filling process of the storage tanks.

Referring to FIG. 1, among others, in operation, the gas supply 104 can include non-breathable air or breathable air (generally referred to as gas herein). The gas supply 104 can include the gas that is in a solid state or liquid state that can be expanded to a gaseous state. For example, the gas supply 104 can include liquid nitrogen for the system 100. The gas supply 104 can boil the liquid nitrogen to produce nitrogen gas for the system 100. The gas can include high levels of toxic gases, inert gases, high concentrations of carbon dioxide, heavy metals, and other pollutants to provide fuel for the various components of the FARS, without causing harm to the firefighter. For example, the gas supply 104 can provide carbon monoxide to the first tank 102 to use for the regulator 108 and the pump 114. The gas supply 104 can include high levels of ambient air for the various components of the FARS. For example, the gas supply 104 can provide high levels of oxygen to the first tank 102 to use for the regulator 108 and the pump 114.

The gas supply 104 can provide gas to the first tank 102 via the fluid channel 106A. For example, the gas supply 104 can transmit gas through the fluid channel 106A to the first tank 102. The gas supply 104 can transmit gas to the first tank 102 at a rate controlled by the regulator 108 based on the needs of the pump 114. For example, the pump 114 may require a higher amount of gas to operate the components (e.g., fans, compressors) within the pump 114. The pump 114 can transmit a signal to the regulator 108 to increase the rate of transmission of the gas from the gas supply 104.

The gas supply 104 can provide gas to each first tank 102 in the plurality of DASTs 102. The plurality of DASTs 102 can include at least three DASTs 102 (e.g., first tank 102A, first tank 102B, first tank 102C). For example, a FARS 100 can include a first tank 102A, a first tank 102B, and a first tank 102C. The gas supply 104 can transmit gas to each first tank 102 at a rate different from another. The gas supply 104 can fill the first tank 102A with gas before filling the first tank 102B. Therefore, the FARS 100 can maintain at least one full first tank 102 at any point during a fire emergency. By having the gas supply 104 supply gas to the first tank 102, the FARS can maintain separate storages for gas from the gas supply 104 and ambient air from the air supply 112.

The first tank 102 can supply gas to the regulator 108 via the fluid channel 106A. The first tank 102 can be fluidically coupled with the regulator 108 to transmit gas (e.g., breathable air or non-breathable air) in a gaseous state to the regulator 108. For example, the first tank 102 can provide gas to the regulator 108 by transmitting gas stored within the first tank 102 to the regulator 108. The regulator 108 can control and maintain the rate of gas within the fluid channel 106A by extracting gas from the first tank 102. For example, the regulator 108 can retrieve more gas from the first tank 102 at a first time period by adjusting to the adjustment knob of the regulator 108. The first tank 102 can have a cylindrical like shape with a material to maintain and store the gas from the gas supply 104. The material of the first tank 102 can include at least one of plastic, aluminum, or Polyvinyl Chloride (PVC). For example, the first tank 102 can be an aluminum cylinder.

The regulator 108 can provide gas from the first tank 102 to the pump 114. For example, the regulator 108 can transmit gas from the first tank 102 to the pump 114 along the fluid channel 106A. The regulator 108 can have a setting corresponding to at least one of a pressure and a rate of gas flow out of the regulator 108, e.g., from the first tank 102 to the pump 114. The regulator 108 can have the setting adjusted. For example, by rotating the adjustment knob of the regulator 108, the rate of gas through the fluid channel 106A can increase or decrease. For example, the firefighter can turn the adjustment knob to increase the rate of gas to the pump 114 through the fluid channel 106A. In another example, the firefighter can turn the adjustment knob to decrease the rate of gas to the pump 114, through the fluid channel 106A. In another example, a processor can transmit a signal to the regulator to increase or decrease the rate of gas to the pump 114.

Using the adjustment knob, the regulator 108 can provide gas to the pump 114 at a pressure to maintain the functionality of the pump 114. The pressure of the regulator 108 can be at least 100 psig. For example, the pressure of the regulator 108 can be 150 psig. In another example, the pressure of the regulator 108 can be 100 psig. In yet another example, the pressure of the regulator 108 can be 115 psig. The pump 114 can transmit a signal to the air refill station or the firefighter if the pressure of the regulator 108 falls below 100 psi. For example, when the pressure of the regulator 108 falls below 100 psig, the pump 114 can transmit a signal to the firefighter. The signal can be at least one of a message, an audio alert, a visual indication, among others. For example, the signal can display a message on a user interface indicating that the pressure of the regulator 108 is below 100 psig. In another example, the signal can flash a light to indicate that the pressure at the regulator 108 is lower than 100 psig.

The air supply 112 can include breathable air (generally referred to as ambient air herein). The air supply 112 can include high levels of ambient air for the various components of the FARS. For example, the air supply 112 can provide high levels of ambient air to the second tank 110 via the fluid channel 106B. In another example, the ambient air from the air supply can provide ambient air to the pump 114.

The air supply 112 can provide ambient air to the second tank 110 via the fluid channel 106B. For example, air supply 112 can transmit ambient air through the fluid channel 106B to the second tank 110. The air supply 112 can transmit ambient air to the second tank 110 at a rate controlled by the needs of the pump 114 or the air refill station 116. For example, the air refill station 116 may be running low on ambient air. The pump 114 can transmit a signal to increase the rate of transmission of the ambient air from the air supply 112. The second tank 110 can be a fill station within the structure or coupled with the side of a vehicle.

The air supply 112 can provide ambient air to each second tank 110 in the plurality of BASTs 110. For example, a FARS 100 can include a second tank 110A, a second tank 110B, and a second tank 110C and the air supply 112 can transmit ambient air to each second tank 110 at a rate different from another. The air supply 112 can fill the tank 110A with gas before filling the subsequent tank 110B. Therefore, the FARS 100 can maintain at least one full second tank 110 during a fire emergency.

The pump 114 can include inlet pumps for the air refill station 116. The inlet pumps can be connected directly to the fluid channel 106B to regulate the rate of ambient air provided to the air refill station 116 from the second tank 110. For example, the inlet pumps can demand a constant rate of ambient air from the second tank 110. The inlet pumps can use a pressure for the pump 114 to provide ambient air to the air refill station 116. The pressure can be at least 3000 psig. For example, the pressure can be 3000 psig. In another example, the pressure can be 4000 psig. In yet another example, the pressure can be 6000 psig. The pump 114 can transmit a signal to the firefighter if the pressure at the pump 114 falls below 3000 psig. For example, when the pressure at the pump 114 below 3000 psig, the pump 114 can transmit a signal to the firefighter at the air refill station 116. The signal can be at least one of a message, an audio alert, a visual indication, among others. For example, the signal can trigger an audio alert indicating that the pressure at the pump 114 is below 3000 psig. In another example, the signal can flash a light to indicate that the pressure at the pump 114 is lower than 3000 psig.

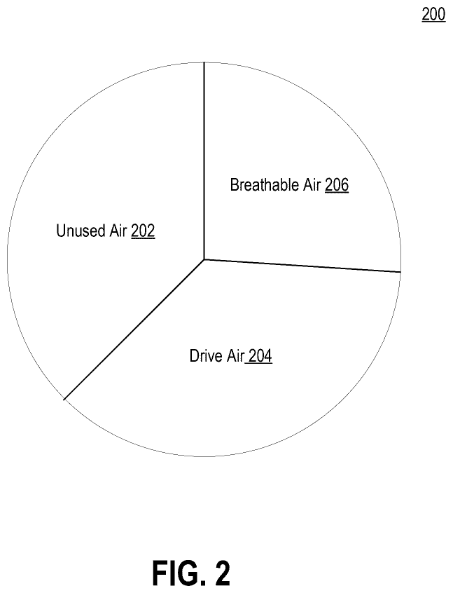

FIG. 2 depicts an example of a first distribution 200 of unused air 202, drive air 204, and breathable air 206, using the FARS 100. Creating separate storage (e.g., first tank 102, second tank 110) for the FARS 100 drive air 204 (e.g., gas from gas supply 104) and the breathing air 206 (e.g., ambient air from air supply 112) to the pump 114 allows the requirements of the air masses (e.g., pressure at the regulator 108 of at least 100 psig, pressure at the air refill station of at least 3000 psig) to be separated. When drive air 204 and breathable air 206 are within the same tanks, the requirements of the air masses must be maintained for all the air within the FARS 100. The at least 3000 psig minimum pressure requirement for the breathable air 206 can limit the total amount of air that can be utilized within the FARS 100. By separating the first tank 102 and the second tank 110, the drive air 204 can deplete below 3000 psig making use of more of the stored air within the FARS 100. Once the drive air 204 is separated from the breathable air 206, other sources of pneumatic power (e.g., “house pneumatic air” or “house nitrogen”) can satisfy the demands of the pump 114. By separating the drive air 204 from the breathing air 206, the pump 114 can utilize materials or gasses that can be stored at higher density than air. Higher density storage can reduce some of the space requirements of the FARS 100, currently certain refrigerant gasses with such as R22, R290, R744 and R410a could provide high density liquid/solid gas storage.

Creating separate storages for the FARS 100 drive air 204 and the breathing air 206, both reservoirs (e.g., first tank 102, second tank 110) can be depleted at the same time. Unlike a single reservoir system, the separated reservoir system, as shown in FIG. 1, can be depleted when the first tank 102 drops below 100 psig or the second tank 110 drops below 3000 psig.

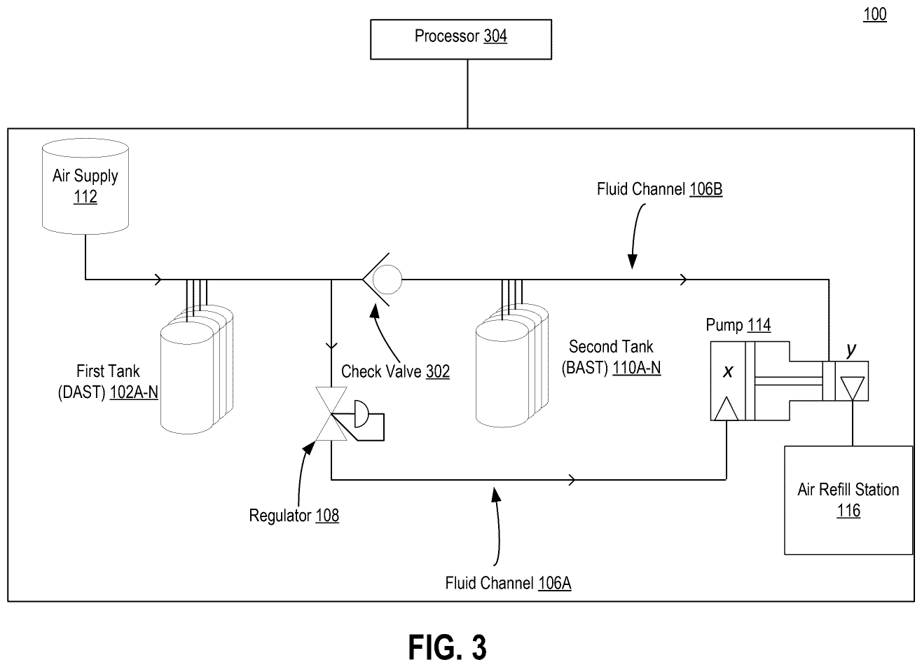

FIG. 3, among others, depicts an example of the system 100, such as a safety system or FARS. For example, the system 100 can include at least the first tank 102, the fluid channel 106A, the fluid channel 106B, the regulator 108, the second tank 110, or the air supply 112. The system 100 can include at least one check valve 302 and at least one processor 304.

The system 100 can include at least one check valve 302. The check valve 302 can be a non-return valve or a one-way valve to allow liquid or gas to flow in one direction through the fluid channel 106 while preventing reverse flow. For example, an open check valve 302 can allow ambient air to flow from fluid channel 106A to fluid channel 106B. In another example, a closed check valve 302 can allow gas to flow throughout the entirety of fluid channel 106A. The check valve 302 can include at least one of an inlet port, a movable component and an outlet port. The moveable component can be at least of a disk or ball. In operation, ambient air from the fluid channel 106A can flow into the inlet port of the check valve 302 while the movable component is open. The ambient air can flow out of the outlet port of the check valve 302 into fluid channel 106B.

The check valve 302 can be electrically coupled to at least one processor 304. The system 100 can include at least one processor 304. The processor 304 can execute one or more instructions associated with the system 100. The processor 304 can include an electronic processor, an integrated circuit, or the like including one or more of digital logic, analog logic, digital sensors, analog sensors, communication buses, volatile memory, nonvolatile memory, and the like. The processor 304 can include, but is not limited to, at least one microcontroller unit (MCU), microprocessor unit (MPU), central processing unit (CPU), graphics processing unit (GPU), physics processing unit (PPU), embedded controller (EC), or the like. The processor 304 can include a memory operable to store or storing one or more instructions for operating components of the processor 304 and operating components operably coupled with the processor 304. For example, the one or more instructions can include one or more of firmware, software, hardware, operating systems, embedded operating systems. The processor 304 or the system 100 generally can include one or more communication bus controller to effect communication between the processor 304 and the other elements of the system 100. The processor 304 can include a plurality of sensors such as a pressure sensor, a proximity sensor, a humidity sensor, a temperature sensor, an ambient light sensor, a smoke sensor, a voltage sensor, a current sensor, among others.

In the system 100, the first tank 102 can house ambient air rather than gas to supply ambient air to the second tank 110 and supply ambient air to the regulator 108. For example, the first tank 102 can receive ambient air from the air supply 112 to provide ambient air to the second tank 110 and to the regulator 108. When the first tank 102 provides ambient air to the second tank 110, the first tank 102 can be treated as the second tank 110 thereby, increasing the amount of breathing air storage within the system 100. The first tank 102 can provide ambient air to the regulator 108 without providing air to the second tank 110 based on the check valve 302. For example, the first tank 102 can provide ambient air to the regulator 108 without providing ambient air to the second tank 110 when the check valve 302 is closed.

The check valve 302 can fluidically couple and decouple the fluid channel 106A with the fluid channel 106B based on a signal from the processor 304. For example, the processor 304 can transmit a signal to close the check valve 302. In response to receiving the signal the check valve 302 can decouple the fluid channel 106A from the fluid channel 106B. In another example, the processor 304 can transmit a signal to open the check valve 302. In response to receiving the signal the check valve 302 can couple the fluid channel 106A with the fluid channel 106B. One or more check valves 302 can be separate from one or more regulators 108, or can be integrally or monolithically provided with one or more regulators 108, e.g., in a valve or manifold structured to perform pressure and/or flow control operations.

The processor 304 can generate the signal using one or more sensors to identify the pressure associated with the drive air storage (e.g., plurality of DASTs 102) within the system 100. For example, the check valve 302 can include a pressure sensor to identify the pressure associated with the drive air storage. When the pressure sensor detects that the pressure associated with the drive air storage exceeds 4500 psig, the processor 304 can generate a first signal to open the check valve 302. For example, when the pressure associated with the drive air storage is 5000 psig, the processor 304 will generate the first signal to open the check valve 302. On the other hand, when the pressure sensor detects that the pressure associated with the drive air storage is below 4500 psig, the processor 304 can generate a second signal to close the check valve 302. For example, when the pressure associated with the drive air storage is 3500 psig, the processor 304 will generate the second signal to close the check valve 302.

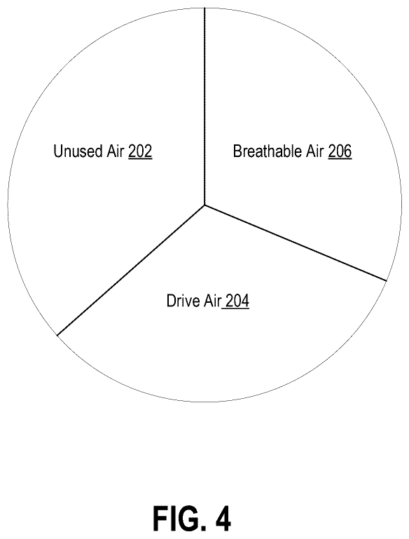

Referring to FIG. 4, depicts an example of a second distribution 200 of unused air 202, drive air 204, and breathable air 206, using the FARS 100. When the drive air 204 is separate from the breathable air 206, the breathing air 206 can drive the pump 114. When the drive air storage pressure is greater than a pump cut in pressure, the system 100 can bypass the pump 114 with the check valve 302 to save the air that would have been consumed running the 118. By adding a second check valve 302 between the drive air storage and breathing air storage allowing the breathing air held in the drive air storage reservoir at pressure greater than the pump cut in pressure to bypass the pump or additional savings in the breathable air 206 and the drive air 204. For FAR systems nominally delivering air at 4500 psig this represents approximately 65 SCF (standard cubic ft) per 510 SCF storage cylinder of additional breathing air delivered. Using the system 100, there can be a reduction in unused air 202, with an increase in drive air 204 and breathable air 206 as shown in the second distribution 200.

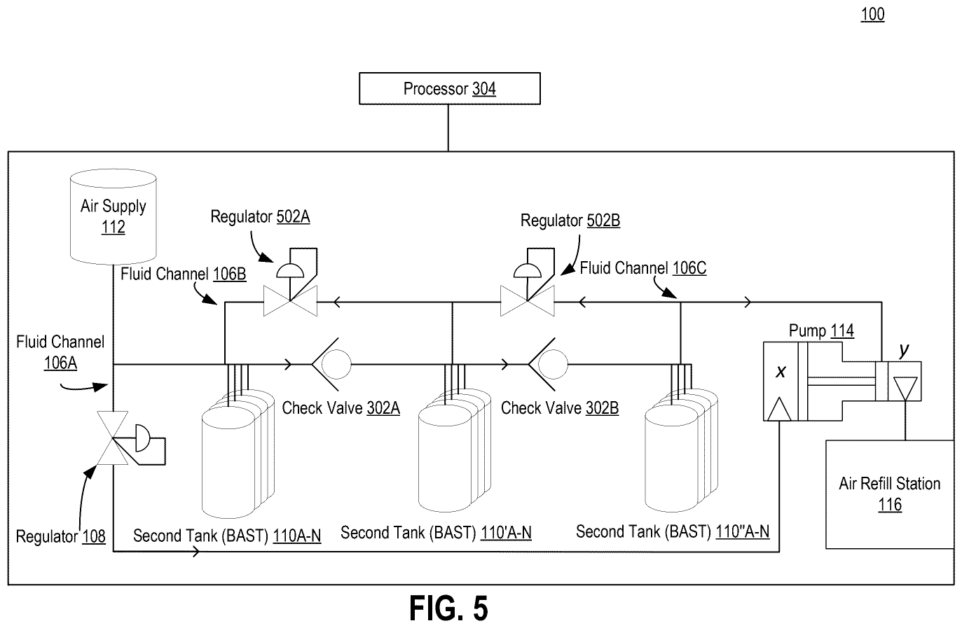

Referring to FIG. 5, depicts a schematic diagram of an example of the system 100, such as a safety system or FARS. For example, the system 100 can include at least the fluid channel 106A, the fluid channel 106B, the regulator 108, the second tank 110, air supply 112, or the processor 304. The system 100 can include plurality of check valves 302 (e.g., check valve 302A, check valve 302B), a plurality of regulators 502 (e.g., regulator 502A, regulator 502A), or a fluid channel 106C. The system 100 can include a first plurality of second tank 110, a second plurality of second tank 110′, and a third plurality of second tank 110″.

Each second tank 110 in the plurality of second tanks 110 (e.g., second tank 110, second tank 110′, second tank 110″) can include at least three second tanks 110. For example, a plurality of second tanks 110 can include three second tanks 110. In another example, a plurality of second tank 110 can include five second tanks 110. The second tanks 110 can be fluidically coupled with the second tank 110′ via the fluid channel 106B. For example, the fluid channel 106B can fluidically couple the second tank 110 with the second tank 110′. The second tank 110′ can be fluidically coupled with the second tank 110 and the second tank 110″ via the fluid channel 106B and fluid channel 106C. For example, the second tank 110′ can be fluidically coupled with the second tank 110 and the second tank 110″ using the fluid channel 106B and fluid channel 106C.

The plurality of regulators 502 can include at least one or more of the various components of the regulator 108. For example, the regulator 502A can include an adjustment knob. In another example, the regulator 502B can include a pressure gauge. The plurality of regulators 502 can be configured to have a pressure that is higher than the pressure of the regulator 108. For example, the pressure at the plurality of regulators 502 can be at least 150 psig.

The check valve 302A can couple or decouple the second tank 110 and the second tank 110′ based on the pressure at the second tank 110 detected by the processor 304. For example, the check valve 302A can decouple the second tank 110 from the second tank 110′ when the processor 304 detects a pressure of at least 100 psig. In another example, the check valve 302A can couple the second tank 110 from the second tank 110′ when the processor 304 detects a pressure of 150 psig. The check valve 302B can couple or decouple the second tank 110′ and the second tank 110″ based on the pressure at the second tank 110′ detected by the processor 304. For example, the check valve 302B can decouple the second tank 110′ from the second tank 110″ when the processor 304 detects a pressure of at least 100 psig. In another example, the check valve 302B can couple the second tank 110′ from the second tank 110″ when the processor 304 detects a pressure of 150 psig.

The processor 304 can close the check valve 302A and the check valve 302B to transmit all the ambient air from the air supply 112 to the regulator 108. For example, the processor 304 can detect that the pressure within the system 100 is greater than 4500 psig. In response to detecting the pressure is greater than 4500 psig, the air supply 112 can transmit all the stored ambient air to the regulator 108. The regulator 108 can transmit the ambient air to the pump 114. When the check valve 302A and the check valve 302B are opened, the second tank 110 and the second tank 110′ can be decoupled from the system 100. While the second tank 110 and the second tank 110′ are decoupled from the system 100, the second tank 110″ can transmit ambient air to the pump 114 until each tank in the second tank 110″ is depleted or the processor 304 detects a pressure less than 4500 psig. For example, When the pressure in the system 100 drops below 4500 psig, the processor 304 can open the check valve 302A and the check valve 302B. In another example, when each tank in the second tank 110″ are depleted, the processor 304 can open the check valve 302A and the check valve 302B.

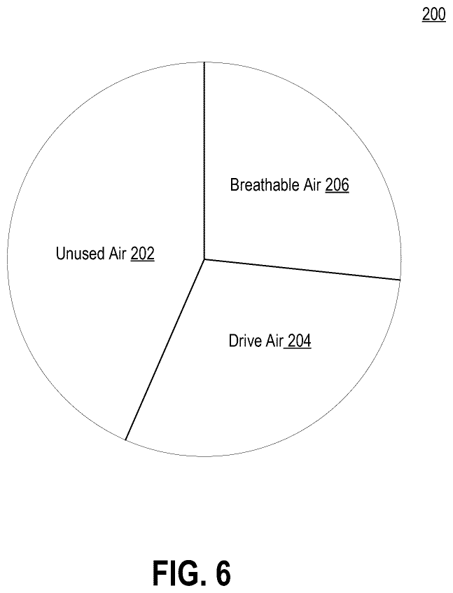

Referring to FIG. 6, depicts an example of a third distribution 200 of unused air 202, drive air 204, and breathable air 206, using the FARS 100. An air-to-air booster pump 114 used in the FAR systems can achieve greater efficiency when the ambient air enters the pump 114 at higher pressure. The drive air (e.g., air to the regulator 108) can be reduced to 100 psig and any additional pressure over the 100 psig used to run the pump 114 can be ignored. By separating the stored air into three or more BASTs 110 and only using one of those storage tanks for drive air at a time, the system 100 can achieve greater pumping efficiency. Using the system 100, more air can be maintained at a higher pressure longer amount of time and allowing for greater pumping efficiency by consuming ambient air via the inlet of the pump 114.

Breaking the Air Storage into three or more separable storage tanks (e.g., tanks of the second tank 110) and using one storage tank at a time to deliver pump 114 drive air can be achieved by placing a check valve 302 (e.g., check valve 302A, check valve 302B) and regulator plurality of regulators 502 (e.g., regulator 502A, regulator 502B) in parallel between the separate banks of air. When the second tank 110 pressure is higher than the inlet pressure of the air refill station 116, air from the second tank 110s flows through the check valves 302 towards the inlet pressure of the air refill station 116. When the pump 114 demand air, the ambient air is fed in the opposite direction through the regulators 502. The system 100 mitigates the problem of the relative sizing of the BASTs 110 in the two reservoir systems as the use of each second tank 110 changes as the system depletes. The system 100 can use one storage tank sub-optimally.

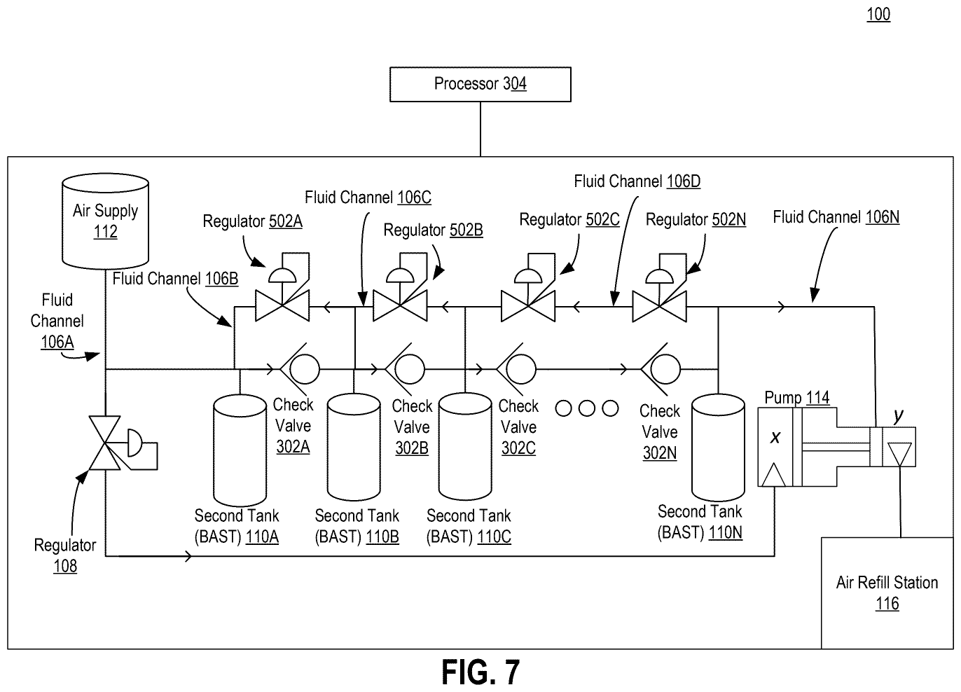

Referring now to FIG. 7, depicts a schematic diagram of an example of the system 100, such as a safety system or FARS. For example, the system 100 can include at least the fluid channel 106A, the fluid channel 106B, the regulator 108, the air supply 112, the processor 304, the plurality of check valves 302, (e.g., check valve 302A, check valve 302B), the plurality of regulators 502 (e.g., regulator 502A, regulator 502B), or the fluid channel 106C. The system 100 can include the plurality of second tank 110A-N and the plurality of fluid channels 106A-N.

The system 100 can include air supply 112 to provide air to the pump 114 and a second tank 110A as described above. Each second tank 110 in the plurality of second tank 110A-N can be fluidically coupled to a subsequent second tank 110, at least one regulator 502 in the plurality of regulators 502A-N, and at least one check valve 302 in the plurality of check valves 302A-N via at least one fluid channel 106 in the plurality of fluid channels 106. For example, the second tank 110A can be fluidically coupled to a second tank 110B via the fluid channel 106B. In another example, the second tank 110B can be fluidically coupled to a second tank 110C via the fluid channel 106C.

The check valve 302A can couple or decouple the second tank 110A from the second tank 110B based on the pressure at the second tank 110A. For example, the processor 304 can transmit a signal to open the check valve 302A when the pressure at the second tank 110A is greater than 4500 psig. When open, the check valve 302A can allow ambient air to travel to the second tank 110B by coupling the second tank 110A to the second tank 110B. In another example, the processor 304 can transmit a signal to close the check valve 302A when the pressure at the second tank 110A is less than 4500 psig. When open, the check valve 302A can block ambient air to travel to the second tank 110B by decoupling the second tank 110A from the second tank 110B.

The check valve 302B can couple or decouple the second tank 110B from the second tank 110C based on the pressure at the second tank 110B. For example, the processor 304 can transmit a signal to open the check valve 302B when the pressure at the second tank 110B is greater than 4500 psig. When open, the check valve 302B can allow ambient air to travel to the second tank 110C by coupling the second tank 110B with the second tank 110C. In another example, the processor 304 can transmit a signal to close the check valve 302B when the pressure at the second tank 110B is less than 4500 psig. When open, the check valve 302B can block ambient air to travel to the second tank 110C by decoupling the second tank 110B from the second tank 110C.

For ease of description, each check valve 302 (e.g., check valve 302A, check valve 302B, check valve 302C) can couple or decouple the corresponding second tank 110 (e.g., second tank 110A, second tank 110B, second tank 110C) connected within the corresponding fluid channel 106.

The regulators 502A-N can provide ambient air from the second tank 110N to the second tank 110A to recirculate unused ambient air within the system 100. For example, the second tank 110N can transmit unused air through each regulator 502 (e.g., regulator 502A, regulator 502B, regulator 502C, regulator 502N) back to the second tank 110A to recirculate unused air within the system 100. The regulators 502A-N can provide ambient air to the second tank 110A at a pressure higher than the regulator 108 and at a pressure lower than the pressure of the air refill station 116. The pressure of the regulators 502A-N can be at least 150 psig.

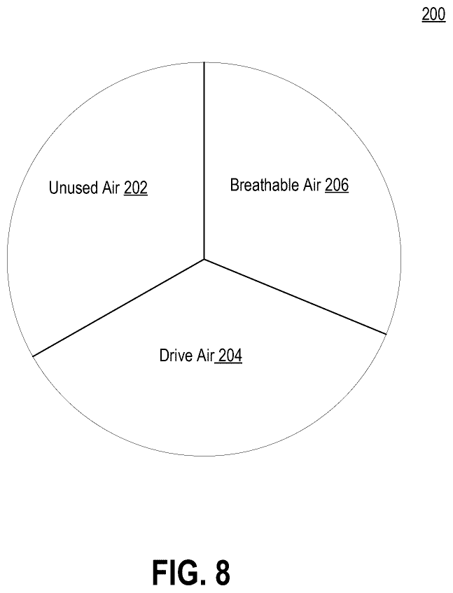

Referring now to FIG. 8, an example of a fourth distribution 200 of unused air 202, drive air 204, and breathable air 206, using the FARS 100. The system 100 uses each storage tank as a separate reservoir. The system 100 can be the most volumetrically efficient use of the breathing air storage, as shown in the fourth distribution 200. The system 100 avoids the problem of the relative sizing of the reservoirs in the two reservoir systems as the use of each storage tank can change as the storage tank depletes. The system 100 can use one storage tank sub-optimally. An additional advantage of the system 100 is if the dynamics of the system change (e.g., if the pump 114 becomes less/more efficient as it ages or is replaced), the system 100 can more effectively use the stored air.

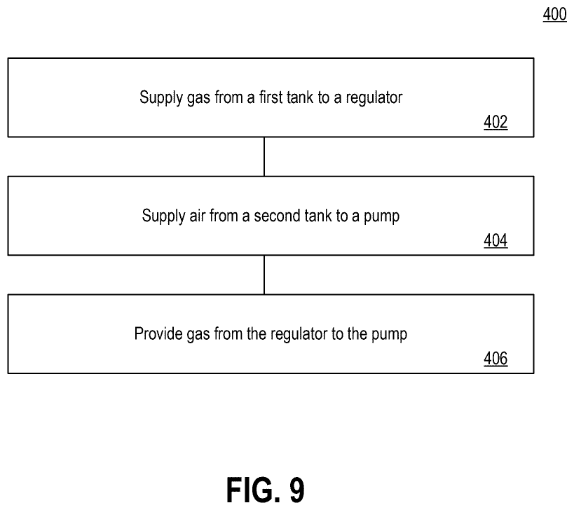

FIG. 9 depicts a flow diagram illustrating an example method 400 for alternatives for drive air storage. The method 400 can include structural elements of system 100. At ACT 402, the method 400 can include supplying gas from a first tank to a regulator. At ACT 404, the method 400 can include supplying air from a second tank to a pump. At ACT 406, the method 400 can include providing gas from the regulator to the pump.

At ACT 402, the method 400 can include supplying gas from a first tank to a regulator. The first tank can be one of a plurality of drive air storage tanks. The plurality of drive air storage tanks can include at least three drive air storage tanks. The first tank (e.g., first tank 102) can supply gas to the regulator (e.g., regulator 108) via a first fluid channel (e.g., fluid channel 106A). The gas can be at least one of a solid or liquid.

At ACT 404, the method 400 can include supplying air from a second tank to a pump. The second tank can be one of a plurality of breathable air storage tanks. The plurality of breathable air storage tanks can include at least three breathable air storage tanks. The second tank (e.g., second tank 110) can supply air to the pump (e. g., pump 114) via a second fluid channel (e.g., fluid channel 106B). The first fluid channel can be separate from the second fluid channel.

The method 400 can include providing, by a valve (e.g., check valve 302), air from the first tank to the second tank along the first fluid channel and the second fluid channel. The valve can couple the first fluid channel with the second fluid channel. The method 400 can include providing, by the plurality of valves, to couple a third fluid channel and a fourth fluid channel with the first fluid channel. The method 400 can include providing, by the plurality of valves, from a first plurality of tanks to a second plurality of tanks. The method 400 can include providing, by a plurality of regulators, air from a second plurality of tanks to the first plurality of tanks.

The method 400 can include supplying, by a fourth tank to a fifth tank, air via a third fluid channel. The method 400 can include supplying air from the fifth tank to a sixth tank via a fourth fluid channel. The method 400 can include coupling, by a valve, the third fluid channel with the fifth fluid channel. The method 400 can include providing, by the regulator, air from the fifth tank to the fourth tank at a pressure that is lower than the pressure of the air supplied to the pump.

At ACT 406, the method 400 can include providing gas from the regulator to at least one of a pump or compressor. The regulator can provide gas to the pump (e.g., pump 114) at a pressure that is lower than a pressure of the air supplied from the second tank to the pump. The pressure of the air supplied to the pump can be between 3000 psig to 6000 psig. The pressure of the gas supplied to the from the regulator is at least 100 psig.

What is claimed is:

1. An air replenishment system, comprising:
a first tank to supply gas to a regulator via a first fluid channel;
a second tank to supply air to a pump via a second fluid channel;
the regulator to provide the gas from the first tank to the pump at a pressure that is lower than a pressure of the air supplied from the second tank to the pump; and
the first fluid channel separate from the second fluid channel.

2. The air replenishment system of claim 1, wherein the first tank is one of a plurality of drive air storage tanks, the plurality of drive air storage tanks including at least three drive air storage tanks.

3. The air replenishment system of claim 1, wherein the second tank is one of a plurality of breathing air storage tanks, the plurality of breathing air storage tanks including at least three breathing air storage tanks.

4. The air replenishment system of claim 1, comprising a valve to couple the first fluid channel with the second fluid channel, the valve to provide air from the first tank to the second tank along the first fluid channel and the second fluid channel.

5. The air replenishment system of claim 1, comprising:
a plurality of valves to couple a third fluid channel and a fourth fluid channel to the first fluid channel, the plurality of valves to provide air from a first plurality of tanks to a second plurality of tanks; and
a plurality of regulators to provide air from the second plurality of tanks to the first plurality of tanks.

6. The air replenishment system of claim 1, comprising:
a fourth tank to supply air to fifth tank via a third fluid channel;
the fifth tank to supply air to a sixth tank via a fourth fluid channel;
a valve to couple the third fluid channel to the fourth fluid channel and provide air from the fourth tank to the fifth tank; and
a second regulator to provide air from the fifth tank to the fourth tank at a pressure that is lower than the pressure of the air supplied to the pump.

7. The air replenishment system of claim 1, wherein the pressure of the air supplied to the pump is between 3000 psig to 6000 psig.

8. The air replenishment system of claim 1, wherein the pressure of the gas supplied to the pump from the regulator is at least 100 psig.

9. The air replenishment system of claim 1, wherein the gas is at least one of a solid state, liquid state, or a gaseous state.

10. The air replenishment system of claim 1, wherein the gas is at least one of pneumatic air or nitrogen.

11. An air replenishment method, comprising:
supplying gas from a first tank to a regulator via a first fluid channel;
supplying air from a second tank to a pump via a second fluid channel; and
providing, by the regulator, the gas from the first tank to the pump at a pressure that is lower than a pressure of the air supplied from the second tank to the pump, with the first fluid channel separate from the second fluid channel.

12. The air replenishment method of claim 11, wherein the first tank is one of a plurality of drive air storage tanks.

13. The air replenishment method of claim 11, wherein the second tank is one of a plurality of breathing air storage tanks.

14. The air replenishment method of claim 11, comprising coupling, by a valve, the first fluid channel with the second fluid channel to provide gas from the first tank to the second tank.

15. The air replenishment method of claim 11, comprising:
providing, by a plurality of valves, air from a first plurality of tanks to a second plurality of tanks via a third fluid channel; and
providing, by a plurality of regulators, air from the second plurality of tanks to the first plurality of tanks via a fourth fluid channel.

16. The air replenishment method of claim 11, comprising:
supplying air from a fourth tank to a fifth tank via a third fluid channel;
supplying air from the fifth tank to a sixth tank via a fourth fluid channel;
coupling, by a valve, the third fluid channel to a fifth fluid channel; and
providing, by the regulator, air from the fifth tank to the fourth tank at a pressure that is lower than the pressure of the air supplied to the pump.

17. The air replenishment method of claim 11, wherein the pressure of the air supplied to the pump is between 3000 psig to 6000 psig.

18. The air replenishment method of claim 11, wherein the pressure of the gas supplied to pump the from the regulator is at least 100 psig.

19. The air replenishment method of claim 11, wherein the gas is at least one of a solid state, liquid state, or a gaseous state.

20. The air replenishment method of claim 11, wherein the gas is at least one of pneumatic air or nitrogen.
